(19) United States
(12) Patent Application Publication
(10) Pub. No.: US 2021/0022295 A1
(43) Pub. Date: Jan. 28, 2021

(54) AGRICULTURAL BALER WITH PASSIVE SPREADER ROLL ASSEMBLY

(71) Applicant: CNH Industrial America LLC, New Holland, PA (US)

(72) Inventor: Scott C. Simmons, Lititz, PA (US)

(73) Assignee: CNH Industrial America LLC, New Holland, PA (US)

(21) Appl. No.: 16/518,590

(22) Filed: Jul. 22, 2019

(51) Int. Cl. A01F 15/07

(52) U.S. Cl. CPC A01F 15/071; A01F 2015/073

(57) ABSTRACT

A wrapping assembly for an agricultural vehicle includes a frame, a material support roll supported by the frame and configured to hold a roll of wrapping material, and a spreader roll assembly configured to spread wrapping material from the roll held by the material support roll and including a first roll supported by the frame and a second roll having at least one pivot. The at least one pivot pivotably couples the second roll to the frame and is positioned such that an exerted force from the wrapping material on the second roll causes the second roll to pivot toward the first roll and pinch the wrapping material between the first roll and the second roll.

### FIELD OF THE INVENTION

The present invention pertains to agricultural vehicles and, more specifically, to agricultural balers.

### BACKGROUND OF THE INVENTION

For many years harvesters, such as agricultural balers, have been used to consolidate and package crop material to facilitate the storage and handling of the crop material for later use. Usually, a mower-conditioner cuts and conditions the crop material for windrow drying in the sun. When the cut crop material is properly dried, a harvester, such as a round baler, the most frequently used in the industry, travels along the windrows to pick up the crop material and form it into cylindrically-shaped round bales.

More specifically, the cut crop material is gathered at the front of the baler from along the ground, onto a pickup assembly, and introduced into a bale-forming chamber within the baler. Inside, the cut crop is rolled up into a predetermined size. A conventional bale chamber may include a pair of opposing sidewalls with a series of belts, chains, and/or rolls that rotate and compress the crop material into the cylindrically-shaped round bale. When the predetermined size is achieved, the cylindrically-shaped round bale is wrapped and bound by wrapping material, such as net wrapping, plastic wrapping, and/or wire. After the round bale is wrapped, the back of the baler, or tailgate, opens and the wrapped bale is discharged.

Wrapping material is fed into the baler off a wrapping material roll and into a wrapping mechanism, conventionally located in the front of the baler. One of the processes managed by the wrapping mechanism is making sure the wrapping material is spread out before being placed on the bale. This ensures that the wrapping material is not bunched or crumpled, but is instead both taut and wide enough to cover the entire width of the bale. Typically, a spread roll is used for this task. Conventional spread rolls comprise a journaled roller placed between two sidewalls of a harvester. Wrapped around the spread roll is one or more coils that travel in a screw-like fashion towards at least one of the sidewalls. As the spread roll rotates, wrapping material in contact with a coil is stretched towards the sidewall, keeping the wrapping material taut as it proceeds towards wrapping the bale. While such rolls may be effective to spread out the wrapping material, there are certain instances when the wrapping material exhibits undesirable spreading behavior.

What is needed in the art is a baler with a spreader roll assembly that can address some of the previously described issues of known spreader roll assemblies.

### SUMMARY OF THE INVENTION

Exemplary embodiments disclosed herein provide a spreader roll assembly with a pivotable roll that may be pivoted toward another roll by force exerted on the pivotable roll by wrapping material to pinch the wrapping material therebetween.

In some exemplary embodiments provided according to the present disclosure, a wrapping assembly for an agricultural vehicle includes a frame, a material support roll supported by the frame and configured to hold a roll of wrapping material, and a spreader roll assembly configured to spread wrapping material from the roll held by the material support roll and including a first roll supported by the frame and a second roll having at least one pivot. The at least one pivot pivotably couples the second roll to the frame and is positioned such that an exerted force from the wrapping material on the second roll causes the second roll to pivot toward the first roll and pinch the wrapping material between the first roll and the second roll.

In some exemplary embodiments provided according to the present disclosure, an agricultural baler includes: a chassis; a pickup carried by the chassis and including a plurality of pickup tines; a frame carried by the chassis; a material support roll carried by the chassis and configured to hold a roll of wrapping material; and a spreader roll assembly configured to spread wrapping material from the roll held by the material support roll and including a first roll coupled to the frame and a second roll having at least one pivot. The at least one pivot pivotably couples the second roll to the frame and is positioned such that an exerted force from the wrapping material on the second roll causes the second roll to pivot toward the first roll and pinch the wrapping material between the first roll and the second roll.

One possible advantage that may be realized by exemplary embodiments disclosed herein is that the second roll is passively pivoted toward the first roll to pinch the wrapping material between the rolls.

Another possible advantage that may be realized by exemplary embodiments disclosed herein is that pinching the wrapping material between the rolls can reduce the risk of the wrapping material being axially pulled along either of the rolls, especially when there is low tension in the wrapping material.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a perspective view of an exemplary embodiment of an agricultural baler including a wrapping assembly, provided in accordance with the present disclosure;

FIG. 2 is a sectional view of the baler of FIG. 1 that illustrates an exemplary embodiment of the wrapping assembly in further detail;

FIG. 3 is a sectional view of the baler illustrated in FIGS. 1-2 as a wrapping material forces a pivotable roll to pivot toward another roll;

FIG. 4 is a perspective view of an exemplary embodiment of a pivot that pivotably couples the pivotable roll to a frame;

FIG. 5 is a perspective rear view of the pivot illustrated in FIG. 4; and

FIG. 6 is another perspective view of the wrapping assembly illustrated in FIGS. 1-4.

### DETAILED DESCRIPTION OF THE INVENTION

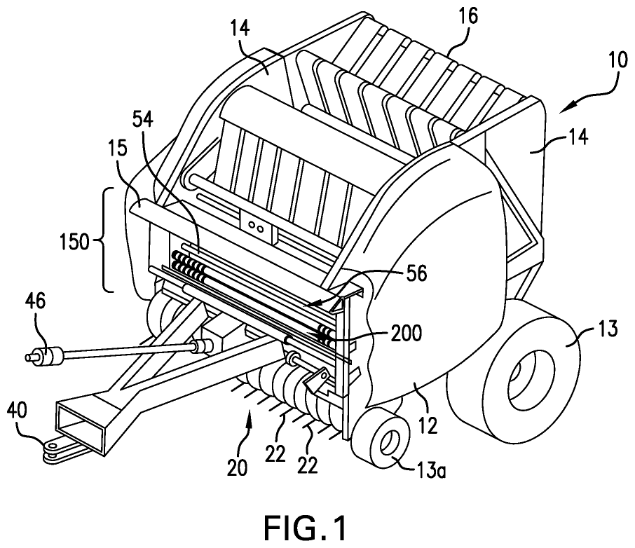

Referring now to the drawings, and more particularly to FIG. 1, an exemplary embodiment of a round agricultural baler 10 provided according to the present disclosure is illustrated. The baler 10 includes a chassis 12, which carries elements of the baler 10 including a pair of opposed walls 14, which may be side walls. The chassis 12 is supported by a pair of rear wheels 13. A forwardly mounted hitch 40, integrated with the chassis 12, provides for connection to a tractor, for examples. As shown, a power take off (PTO) shaft 46, is located herein about the hitch 40. In other balers, the PTO shaft may be located and connected to the tractor below the hitch. The PTO shaft draws energy from a tractor driving the hitch and transfer that energy to drive mechanisms in the baler 10. Rear side 16, typically comprises a tailgate that is closed during bailing and opened to eject finished bales. In conventional balers, storage to house spare rolls of wrapping material is typically located about the tailgate. The front side 15 of the baler faces the rear of a tractor as connected to by the hitch 40 and the PTO shaft 46. At the bottom of the front side, between a front pair of wheels 13a, and carried by the chassis 12, is a pickup 20. The pickup 20 is supported by the pair of front wheels 13a. Pickup tines 22 wrap around and connect within the pickup 20. The tips of the tines 22 are movable along a predetermined path along the ground to lift crop material from the ground and deliver it rearward along a generally horizontal path towards a floor roll at the bottom of the latter, which is rotatably mounted on the chassis 12. During baling, the floor roll conveys crop material further rear into a bale chamber where belts then urge the material upwardly and forwardly into engagement with sledge rolls. The sledge rolls coil crop material in a round direction to form and add to a bale acre. Continued feeding by pickup tines 22 urge additional crop material into the forming bale in a generally spiral fashion growing the bale core. A wrapping assembly 150 comprises a material support roll 54. When the baler is in use, the material support roll 54 holds a roll of wrapping material which is spread by a spreader roll assembly 200 as wrapping material is fed into a feeding entry 56.

In known balers, spreader rolls are included to spread wrapping material, such as netting, so the wrapping material can wrap an entire width of a formed bale as the wrapping material is fed. In certain instances, little or no tension is applied to the wrapping material, which can result in the wrapping material being pulled axially, i.e., in a direction of the length, along the spreader roll. This tends to occur when the bale first starts forming and can result in the wrapping material not being fully spread when fed and the bale not being properly wrapped.

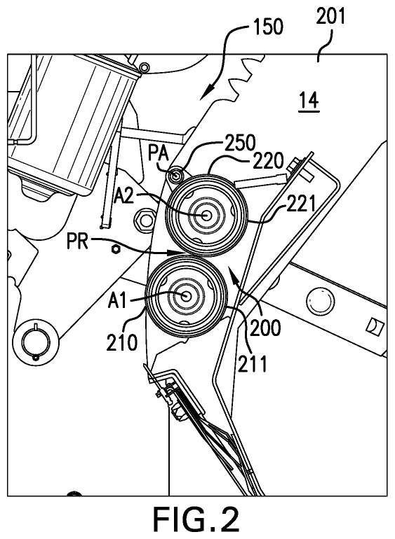

To address some of the previously described issues, an exemplary embodiment of a wrapping assembly 150 is provided according to the present disclosure and illustrated in FIG. 2. The wrapping assembly 150 includes a spreader roll assembly 200 supported by a frame 201, which is carried by the chassis 12 and may include opposed side walls 14. The spreader roll assembly 200 includes a first roll 210 and a second roll 220. The first roll 210 is coupled to the frame 201, such as at least one of the opposed side walls 14, and the second roll 220 is pivotably coupled to the frame 201, such as to at least one of the opposed side walls 14. In some embodiments, the first roll 210 is fixedly coupled to both side walls 14 so the first roll 210 remains generally static, relative to the side walls 14, during operation, as will be described further herein. The first roll 210 may be a bottom roll and the second roll 220 may be a top roll, i.e., the first roll 210 is positioned beneath the second roll 220. The first roll 210 and the second roll 220 may define a pinch region PR, which represents a region where the rolls 210, 220 come together when the second roll 220 pivots toward the first roll 210, as will be described further herein. In some embodiments, the rolls 210, 220 may each have a generally cylindrical shape defined about a respective center axis A1, A2. The cylindrical shape of the rolls 210, 220 may be of a constant diameter across a length of the rolls 210, 220 or, alternatively, may have two or more regions of differing diameter.

The second roll 220 is pivotably coupled to the frame 201, such as to the side walls 14, by at least one pivot 250, such as a pair of pivots 250, with only one pivot 250 being illustrated in FIG. 2. Each of the pivots 250 may pivotably couple a respective end of the second roll 220 to a respective one of the side walls 14. The pivots 250 each define a respective pivot axis PA, which are co-axial, of the coupled second roll 220 so the second roll 220 can passively pivot about the pivot axis PA when a force is applied to the second roll 220, as will be described further herein.

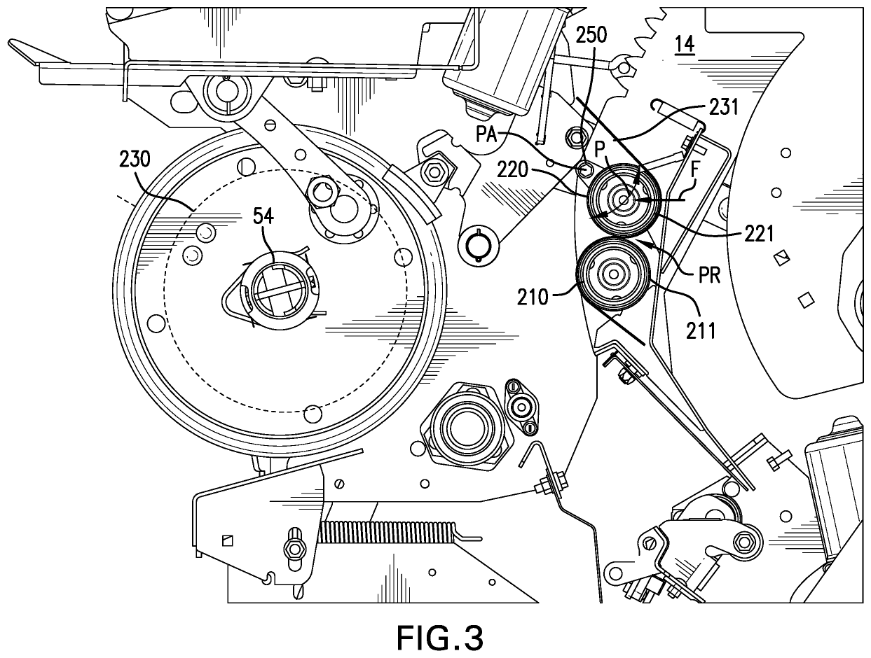

With further reference to FIG. 2, and referring now to FIG. 3 as well, it can be seen that the material support roll 54, which may hold a roll 230 of wrapping material 231, is supported by the frame 201 and provided to hold the roll 230 as the wrapping material 231 is fed to wrap forming bales. The wrapping material 231 is wrapped around the second roll 220 and the first roll 210. When the wrapping material 231 is wrapped around the rolls 210, 220, the wrapping material 231 exerts a force F on the second roll 220 that causes the second roll 220 to pivot about the pivot axis PA of the pivot 250 toward the first roll 210. The pivoting of the second roll 220 due to the exerted force F is illustrated as a curved arrow P. The pivoting of the second roll 220 toward the first roll 210 brings the second roll 220 close enough to the first roll 210 to pinch the wrapping material 231 in the pinch region PR between the rolls 210, 220. In some embodiments, the pinch region PR may be a region where a separation between the rolls 210, 220 is less than a thickness of the wrapping material 231 so pinching the wrapping material 231 causes deformation of the wrapping material 231. It should be appreciated that the positioning of the second roll 220 with respect to the first roll 210, as well as the positioning of the pivot 250, can be adjusted in any fashion that allows the exerted force F on the second roll 220 from the wrapping material 231 to pivot the second roll 220 toward the first roll 210 and pinch the wrapping material 231 between the rolls 210, 220.

Pinching the wrapping material 231 between the rolls 210, 220 reduces the risk of the wrapping material 231 moving axially along the rolls 210, 220 and not fully spreading. Further, because the exerted force F that pivots the second roll 220 toward the first roll 210 comes from the wrapping material 231, rather than a separate machine element such as a spring, the spreader roll assembly 200 is a robust, passive system. Foregoing separate machine elements that provide the force to pivot the second roll 220 toward the first roll 210 reduces the complexity of the wrapping assembly 150 and also reduces maintenance associated with separate machine elements, such as replacing worn springs. Thus, the wrapping assembly 150 provided according to the present disclosure can reduce the risk of the wrapping material 231 moving axially along the rolls 210, 220 using a relatively simple and robust construction.

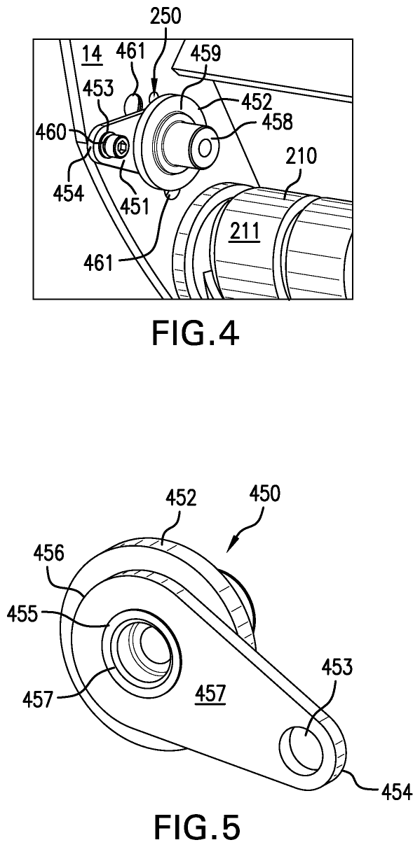

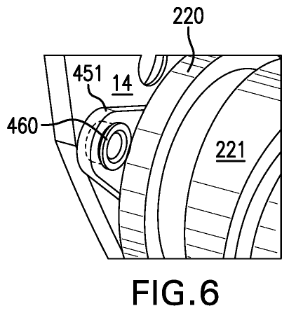

Referring now to FIGS. 4-6, an exemplary embodiment of one of the pivots 250 pivotably coupling the second roll 220 to one of the side walls 14 is illustrated in further detail. The pivot 250 includes a pivot arm 451 and an end bearing 452 coupled to the pivot arm 451 and supporting a respective end of the second roll 220, as illustrated in FIGS. 2 and 6. The pivot arm 451 has a pivot opening 453 formed therein. The pivot arm 451 may, for example, have a propeller-like shape with the pivot opening 453 formed adjacent to one end 454 and a bearing opening 455 formed adjacent to an opposite end 456, as illustrated in FIG. 5.

A pivot pin 460, which is coupled to the side wall 14 of the frame 201, is placed in the pivot opening 453 and defines the pivot axis PA of the pivot arm 451 and the coupled end bearing 452. The pivot pin 460 may be coupled to the side wall 14 by, for example, being placed in a respective one of multiple pin mounting openings 461 formed in the wall 14. Mounting the pivot pin 460 in the different multiple pin mounting openings 461 can adjust the pivot behavior of the second roll 220 and also allow pivotable coupling of differently sized second rolls to the frame 201.

The end bearing 452 coupled to the pivot arm 451 may include a portion 457 disposed in the bearing opening 455 to couple the end bearing 452 to the pivot arm 451. The portion 457 may, for example, be welded into the bearing opening 455. As illustrated in FIG. 4, the end bearing 452 may also include a roll mounting portion 458 that extends from a base 459 of the end bearing 452 and has a cylindrical shape to support the second roll 220. The base 459 may, for example, have an annular shape and bear against a surface of the pivot arm 451.

Each of the rolls 210, 220 has a respective rolling surface 211, 221. In some embodiments, at least one of the rolling surfaces 211, 221 comprises a material that encourages gripping of the wrapping material 231 by the rolls 210, 220. For example, the rolling surfaces 211, 221 may each comprise a rubber, which may form an entirety of the rolling surfaces 211, 221. It should be appreciated that while at least one of the rolling surfaces 211, 221 is described as comprising a rubber, the rolling surfaces 211, 221 can comprise other similar materials to encourage gripping of the wrapping material 231 during operation. In some embodiments, one or both of the rolls 210, 220 comprises a metal material, such as steel, that is coated with a rubber to form a rubber rolling surface. In some embodiments, one or both of the rolls 210, 220 may instead comprise a rubber that is covered with a metal material, such as steel, to form a steel rolling surface. As illustrated in FIG. 1, one or both of the rolls 210, 220 may have grooves, such as helical grooves, formed in the respective rolling surface 211, 221, but it should be appreciated that one or both of the rolls 210, 220 may also be formed with a rolling surface 211, 221 that lacks grooves, helical or otherwise.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A wrapping assembly for an agricultural vehicle, comprising:
a frame;
a material support roll supported by the frame and configured to hold a roll of wrapping material; and
a spreader roll assembly configured to spread wrapping material from the roll held by the material support roll and comprising a first roll supported by the frame and a second roll comprising at least one pivot, the at least one pivot pivotably coupling the second roll to the frame and being positioned such that an exerted force from the wrapping material on the second roll causes the second roll to pivot toward the first roll and pinch the wrapping material between the first roll and the second roll.

2. The wrapping assembly of claim 1, wherein the frame comprises a pair of opposed walls and the first roll is fixedly coupled to both of the opposed walls.

3. The wrapping assembly of claim 1, wherein the first roll is a bottom roll and the second roll is a top roll.

4. The wrapping assembly of claim 1, wherein the at least one pivot comprises a pivot arm comprising a pivot opening and an end bearing coupled to the pivot arm and supporting a respective end of the second roll.

5. The wrapping assembly of claim 4, further comprising a pivot pin placed in the pivot opening and coupled to the frame, the pivot pin defining a pivot axis of the pivot arm and the end bearing.

6. The wrapping assembly of claim 4, wherein the pivot arm comprises a bearing opening and the end bearing coupled to the second roll comprises a portion disposed in the bearing opening.

7. The wrapping assembly of claim 1, wherein at least one of the first roll or the second roll comprises a rolling surface comprising a rubber.

8. The wrapping assembly of claim 7, wherein the rolling surface comprises at least one helical groove formed therein.

9. The wrapping assembly of claim 1, further comprising a roll of wrapping material mounted on the material support roll.

10. The wrapping assembly of claim 1, wherein the frame comprises a pair of opposed walls and the at least one pivot comprises a pair of pivots, each of the pivots pivotably coupling the second roll to a respective one of the opposed walls.

11. An agricultural vehicle, comprising:
a chassis;
a pickup carried by the chassis and comprising a plurality of pickup tines;
a frame carried by the chassis;
a material support roll carried by the chassis and configured to hold a roll of wrapping material; and
a spreader roll assembly configured to spread wrapping material from the roll held by the material support roll and comprising a first roll coupled to the frame and a second roll comprising at least one pivot, the at least one pivot pivotably coupling the second roll to the frame and being positioned such that an exerted force from the wrapping material on the second roll causes the second roll to pivot toward the first roll and pinch the wrapping material between the first roll and the second roll.

12. The agricultural vehicle of claim 11, wherein the frame comprises a pair of opposed walls and the first roll is fixedly coupled to both of the opposed walls.

13. The agricultural vehicle of claim 11, wherein the first roll is a bottom roll and the second roll is a top roll.

14. The agricultural vehicle of claim 11, wherein the at least one pivot comprises a pivot arm comprising a pivot opening.

15. The agricultural vehicle of claim 14, further comprising a pivot pin placed in the pivot opening and coupled to the frame, the pivot pin defining a pivot axis of the pivot arm.

16. The agricultural vehicle of claim 14, wherein the pivot arm comprises a bearing opening and the end bearing coupled to the second roll comprises a portion disposed in the bearing opening.

17. The agricultural vehicle of claim 11, wherein at least one of the first roll or the second roll comprises a rolling surface comprising a rubber.

18. The agricultural vehicle of claim 17, wherein the rolling surface comprises at least one helical groove formed therein.

19. The agricultural vehicle of claim 11, further comprising a roll of wrapping material mounted on the material support roll.

20. The agricultural vehicle of claim 11, wherein the frame comprises a pair of opposed walls and the at least one pivot comprises a pair of pivots, each of the pivots pivotably coupling the second roll to a respective one of the opposed walls.
